(19) United States
(12) Patent Application Publication
(10) Pub. No.: US 2009/0248456 A1
(43) Pub. Date: Oct. 1, 2009

(54) NOTIFICATIONS AND REPORTS IN A RESERVATION SYSTEM

(75) Inventors: Sam Fahmy, Brookline, MA (US); Himanshu Roongta, Stoughton, MA (US)

Correspondence Address: COOLEY GODWARD KRONISH LLP;ATTN: Patent Group, Suite 1100, 777 - 6th Street, NW, WASHINGTON, DC, 20001, US

(73) Assignee: Passkey International, Inc., Quincy, MA (US)

(21) Appl. No.: 12/058,084

(22) Filed: Mar. 28, 2008

(51) Int. Cl. G06Q 10/00

(52) U.S. Cl. 705/5

(57) ABSTRACT

Computer-implemented methods and systems can provide notifications and reports over a network about lodging associated with an event.

### TECHNICAL FIELD

This invention generally relates to providing notifications and reports over a computer network in a reservation system.

### BACKGROUND INFORMATION

Reservation systems that operate over computer networks are known. One such system has a server computer in communication with multiple user or client computers over a network. The server typically has, or has access to, a database for storing information about reservations. Known reservation systems allow users to book lodging at a hotel, but such systems typically only provide limited ability to review or track the status of bookings at the hotel.

### SUMMARY OF THE INVENTION

Methods and systems according to the invention can provide notifications and reports about room inventory at one or more hotels, and those notifications and reports can be sent electronically in one or more ways including as or by electronic mail (email), text message, and instant message, for example. The rooms available at the hotel(s) can be rooms associated with an event happening at the hotel(s) and organized or planned by one or more event planners or event organizers. One or more employees of the hotel(s) can work with one or more of the planners and also with a reservation system according to the invention to identify an inventory of rooms available for reservation online by attendees of the event. Each of the attendees of the event can then use an Internet address and/or a reservation code to access the reservation system and reserve one or more rooms. In accordance with the invention, any one or more of the planners and/or hotel employees (and/or other interested people for that matter) can set conditions or milestones and/or set reporting parameters that result in one or more notifications and/or reports being sent out electronically to any desired person or people. These notifications can be an alert that the set conditions or milestones have been met, and these reports can be periodic reports with status or other set information.

In a reservation system according to the invention, both the event planners and the hotel employees can be considered administrators of the system and also even as sellers in the system, in that they generally together arrange the event and provide the room inventory at the hotel(s) for attendees of the event. Typically, the event planner(s) arrange and organize the event, and the hotel employee(s) provide an inventory of rooms available to attendees of the event via the reservation system. Hotel employee(s) can arrange and organize events independent from or together with event planners, however. The attendees of the event can be considered as consumers or buyers in the system, in that they are the ones that register for and attend the event and also reserve and occupy the rooms. The term invitee is used herein to refer generally to a type of attendee that has received or will receive an invitation or some other notice about an event. The term attendees includes invitees. Some attendees might not be invitees. Attendees at an event can include attendees that were specifically invited (invitees) and/or attendees that registered and reserved rooms through a reservation system according to the invention without having received an invitation directed specifically to them.

The administrators/sellers generally want to know about the room inventory and how it changes over time as attendees/buyers reserve rooms from the inventory. By configuring the system to automatically send out electronically notifications and/or reports to the administrators/sellers as desired by the administrators/sellers, these administrators/sellers are kept informed of the status of the room inventory in the way and in the format that is most useful and helpful to them.

Methods and systems according to the invention thus can provide notifications and reports associated with an inventory of rooms to one or more event planners and/or to one or more of the staff of the hotel(s) providing the room inventory. The planner(s) and/or the hotel employee(s) can identify one or more parameters associated with the inventory of rooms available for an event. The parameter(s) when met can be the trigger(s) for a system according to the invention to send out electronically the notification(s) to the identified recipient(s). The parameters can be any one or more of, for example, the number of rooms still available, percentage of rooms reserved for the event, one or more dates arriving or having passed, etc. The parameters instead or in addition could be information to be included in a report to be sent out, such information including, for example, check-in or check-out dates, waitlist, reservation errors, etc. The planner(s) and/or the hotel employee(s) also can identify each of the recipients of the notifications and/or the reports, and the recipients can be identified by their email addresses, for example. The recipients could be, for example, each of the members of some team that organized the event or that is otherwise associated with the event.

The planner(s) and/or hotel employee(s) can set report contents and frequency by logging onto a reservation system according to the invention and providing the desired settings. The planner(s), hotel employee(s), and/or other recipient(s) then automatically receive electronically the reports based on those settings. The planner(s) and/or hotel employee(s) can set, for example, when the report(s) are sent such as daily, weekly, or monthly.

In one aspect, the invention relates generally to a computer-implemented method of providing a notification over a network. This particular method comprises allowing at least one person associated with an event (such as one or more event planners and/or one or more hotel employees, for example) to identify at least one condition associated with an inventory of rooms available for reservation in connection with the event, and then receiving over the network one or more room reservation requests where each of the requests is for a reservation of one or more of the rooms in the inventory. The method also comprises determining whether the at least one condition associated with the inventory is met after the one or more requests are received, and then providing the notification over the network if the at least one condition is met.

Embodiments according to this aspect of the invention can include, for example, allowing the person (or people) to set as a condition an amount of reserved rooms in the inventory and/or to set a percentage of reserved rooms in the inventory, and then determining whether the amount or the percentage is reached. An electronic mail message can be sent over the network if the at least one condition is met, and the email can include information about that met condition and/or it can include a reference (such as an Internet address or hyperlink) to information about the condition. The email can be sent to the person (or people) and/or to one or more other recipients associated with the event such as, for example, one or more employees of a hotel having at least some of the reserved rooms from the inventory.

In another aspect, the invention generally relates to a computer-implemented method of managing an inventory of rooms over a network. This method comprises offering the inventory of rooms to invitees of an event for reservation, identifying at least one condition for the sending of information associated with the inventory of rooms, and receiving a notification over the network after the at least one condition is met. The person or people that receive the notification can be the person or people that identified the condition and/or can be one or more others associated with the event.

In yet another aspect, the invention generally relates to a computer-implemented method that comprises allowing at least one person associated with an event to schedule at least one report associated with an inventory of rooms available for reservation in connection with the event, receiving over a network one or more room reservation requests where each of the requests is for a reservation of one or more of the rooms in the inventory, and sending the at least one report over the network.

Embodiments according to this aspect of the invention can include, for example, allowing the person (or people) to identify the contents and/or format of the report(s) and also when the report(s) will be sent such as daily, weekly, or monthly. An email sent over the network can include the report(s). The email can have, for example, the report(s) within the body of the email, the report(s) as an attachment to the email, and/or a reference (e.g., Internet address or hyperlink) to some other location where the report(s) can be found. The report(s) can be sent to any number of identified recipients.

In still another aspect, the invention generally relates to a computer-implemented method of managing an inventory of rooms over a network. This method comprises offering the inventory of rooms to invitees of an event for reservation, scheduling at least one report associated with the inventory of rooms, and receiving the at least one report over the network.

Another aspect of the invention generally relates to a computer system for providing a notification over a network. The system comprises a network interface configured to be in communication with the network, storage configured to store data associated with an inventory of rooms available for reservation by invitees of an event, and a processor in communication with the network interface and the storage. The processor is configured to receive one or more conditions associated with the inventory, receive over the network one or more requests for reserving one or more rooms from the inventory, determine whether the one or more conditions are met, and transmit the notification over the network if at least one of the one or more conditions is met.

Other aspects, features, advantages, and objects according to the invention will become more apparent when the accompanying drawings and the following description are considered. The drawings are not necessarily to scale, and they are intended at least to illustrate concepts and embodiments according to the invention but not to be limiting on or restrictive of the invention.

### BRIEF DESCRIPTION OF THE DRAWINGS

FIG. 1A shows a system block diagram of a reservation system with various participant computing devices depicted communicating over a computer network, according to an embodiment of the invention.

FIG. 1B shows a system block diagram of the reservation system with more than one of certain of the devices in the reservation system depicted.

FIG. 2 shows a system block diagram of an embodiment of the computing devices of the reservation system of FIGS. 1A and 1B.

FIG. 3 shows a system block diagram of a reservation system depicting various interactions.

FIG. 4 shows series of web pages for selecting a notification.

FIG. 5 shows a flow chart for a providing a notification.

FIG. 6 shows a web page for configuring parameters of a notification.

FIG. 7 shows a web page for selecting recipients of a notification.

FIG. 8 shows a template for an email notification.

FIG. 9 shows an example of an email notification.

FIG. 10 shows an example of an email for informing a user that notifications will be sent to that user.

FIG. 11 shows a flow chart for scheduling a notification.

FIGS. 12 and 13 show web pages for configuring parameters of a notification.

FIG. 14 shows web pages for scheduling a notification.

FIG. 15 shows an example of an email notification.

FIG. 16 shows an example of an email notification.

### DESCRIPTION

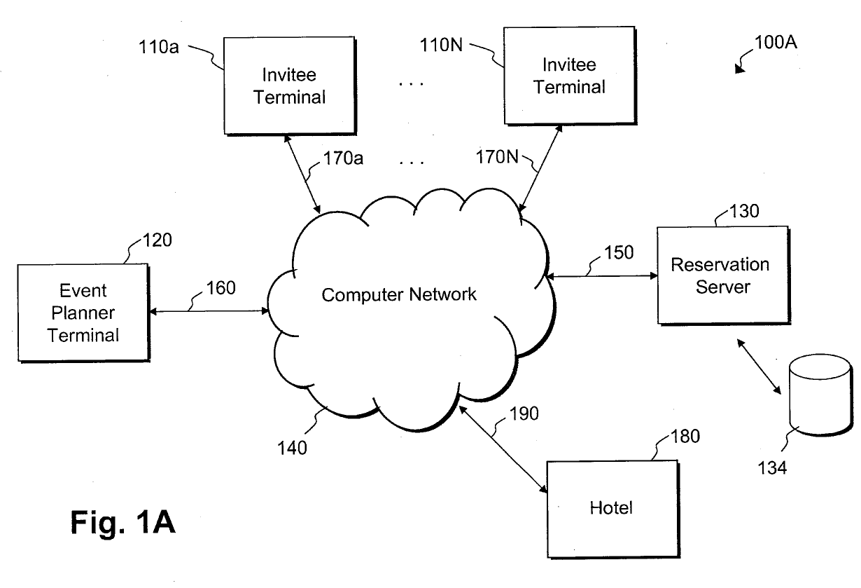

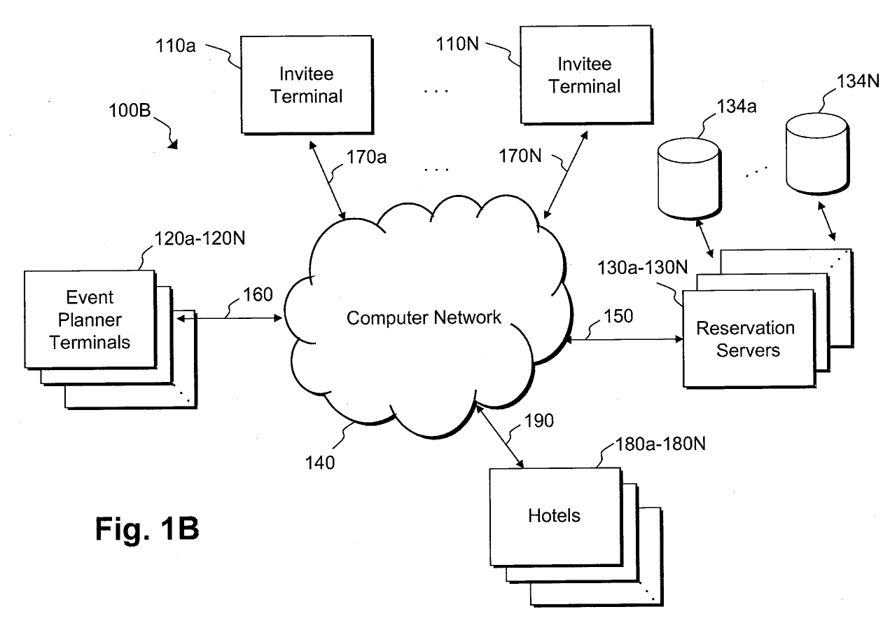

Referring to FIG. 1A, an embodiment of a reservation system 100A with various participant computing devices is depicted communicating over a computer network 140. The reservation system 100A includes invitee terminals 110a-110N, an event planner terminal 120, a reservation server 130, a database 134, and a hotel 180 connected to the computer network 140. Invitee terminals 110a-110N are connected to the network 140 via connections 170a-170N. The event planner terminal 120 is connected to the network 140 via connection 160. The reservation server 130 is connected to the computer network 140 via connection 150. One or more computers at the hotel 180 are connected to the computer network 140 via connection 190.

The reservation server 130 is operatively coupled to the database 134 such that the reservation server 130 can store data in the database 134 and retrieve data from the database 134. Such data can be, for example, data associated with an inventory of rooms available for an event, conditions and report schedules indicated by an event planner and/or hotel employee, usernames, passwords, and/or reservation codes. In some embodiments, as shown in FIG. 1A, the database 134 is directly coupled to the reservation server 130. For example, the database 134 can be implemented as part of the reservation server 130 or can be directly connected to the reservation server 130. In other embodiments, the database 134 can be operatively coupled to the network 140 such that the reservation server 130 is in communication with the database 134 via the network 140. In yet other embodiments, the database 134 and reservation server 130 can be operatively coupled to another network such that the reservation server 130 is in communication with the database 134 via a network other than network 140.

The reservation server 130 can provide a web-based system for managing and interacting with other components of the system 100A. In other embodiments, specialized software configured to communicate through the network 140 with the reservation server 130 can be provided to event planners, invitees, and hotels for use on the event planner terminal 120, the invitee terminals 110a-110N, and computers at the hotel 180. The event planner terminal 120, invitee terminals 110a-110N, and computers at hotel 180 can be general purpose computers with Internet browsing software and/or dedicated computers at, for example, a point of sale. The reservation server 130 can implement user accounts or profiles that differentiate between types of users such as, for example, event planners and hotel employees. For example, event planner accounts and hotel employee accounts may allow one or more event planners and/or one or more hotel employees to setup or allocate one or more inventories of rooms available for one or more events and also configure or set alert conditions as well as report contents and frequency. Invitees generally use general purpose client computers (desktops, laptops, handheld computing devices, etc.) 110a-110N running browser applications (such as Microsoft's Internet Explorer client browser application) to access and communicate over the computer network 140 with the reservation server 130.

In some embodiments, the reservation server 130 allows event planners and/or hotel employees to log on using usernames and passwords. One or more hotel employees can communicate to the event planner(s) the available room inventory for the reservation server 130 to make available to invitees which then the event planner(s) will input into the reservation server 130, or the hotel employee(s) can log onto the reservation server 130 directly and input into it the available room inventory. The reservation server 130 can maintain and run multiple events and their associated room inventories in parallel and at the same time, allowing invitees or whomever to access a web page (or a set of web pages) for each of the multiple events using a different Internet address for each event typically. The web page(s) for each event can be customized for the particular event and such that invitees and others interested in that particular event realize they are registering and reserving one or more rooms for their particular event.

In one typical embodiment, the invitees are informed of an event outside of the reservation system 100A, such as by an email, a phone call, or other communication to them as determined by the event planner or some other entity engaged to inform invitees of the event. The informed invitees then use the Internet address they are provided to access the reservation server 130 and indicate their interest in attending the event and their need for one or more hotel rooms, providing during the on-line reservation process any reservation code and/or other information they may have been provided when informed of or invited to the event. In general, registering for an event and reserving hotel rooms for the event via the reservation server 130 is not limited to invitees, in that any person that somehow gets the proper Internet address for the event can enter that address into a client-side web browser on a computer and register for the event and/or reserve one or more hotels rooms associated with the event using the reservation server 130.

In an alternative embodiment, the reservation server 130 allows the event planner via the event planner terminal 120 to provide a list of invitees for the event. In this alternative embodiment, the list of invitees includes an electronic mail address for each invitee, and the reservation server 130 uses, for example, the email addresses to establish invitee accounts. These invitee accounts on the reservation server 130 can be accessed using, for example, invitee terminals 110a-110N and can be protected with usernames and passwords. The reservation server 130 can additionally send invitations to each invitee via email or some other electronic communication.

The reservation server 130 can allow the event planner terminal 120 to indicate a condition associated with an inventory of rooms available for reservation that, when met, will trigger a notification. The hotel itself can set such a condition as well by the hotel logging onto and accessing the reservation server 130 directly. In some embodiments, event planner terminal 120 and/or the hotel 180 can indicate that a notification be sent when the percentage of available rooms in the inventory of rooms falls below a certain percentage. In other embodiments, the reservation server 130 may allow event planner terminal 120 and/or the hotel 180 to schedule a periodic report that includes information associated with the inventory of rooms. Thus, as described in more detail below, reservation server 130 can monitor, evaluate, and/or determine various parameters associated with the inventory of rooms.

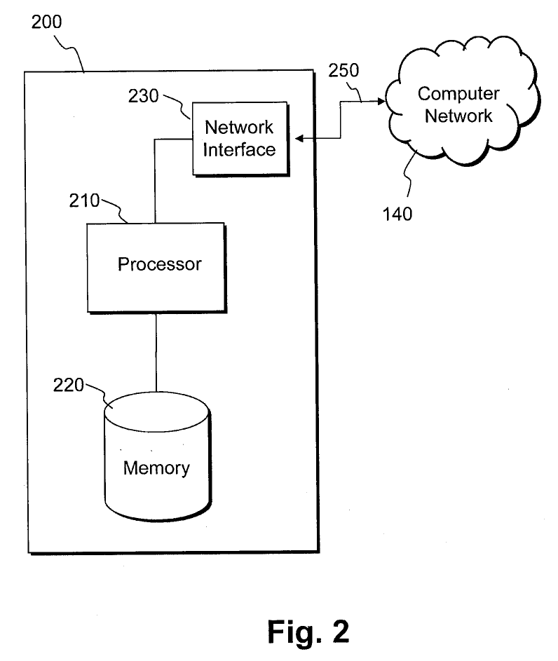

FIG. 1B illustrates a system block diagram of a reservation system with more than one of certain of the devices in the reservation system depicted, according to an embodiment of the invention. FIG. 1B shows reservation system 100B including invitee terminals 110a-110N, event planner terminals 120a-120N, reservation servers 130a-130N, hotels 180a-180N, databases 134a-134N, and computer network 140. Similar to reservation system 100A in FIG. 1A, invitee terminals 110a-110N are connected to network 140 via connections 170a-170N; event planner terminals 120a-120N are connected to network 140 via connections 160; reservation servers 130a-130N are connected to computer network 140 via connections 150; databases 134a-134N are operatively coupled to one or more of reservation servers 130a-130N; and hotels 180a-180N are connected to computer network 140 via connections 190. Additionally, the block diagram illustrated in FIG. 2, discussed below, is representative of an embodiment of invitee terminals 110a-110N, event planner terminals 120a-120N, reservation servers 130a-130N, and hotels 180a-180N.

Reservation system 100B illustrates an embodiment having multiple reservation servers 130a-130N. In some embodiments, reservation servers 130a-130N can be used for system redundancy to provide backup should one of reservation servers 130a-130N malfunction. In other embodiments, reservation servers 130a-130N are distributed geographically to provide reliability and greater access speed to reservation servers 130a-130N from event planner terminals 120a-120N, invitee terminals 110a-110N, and/or hotels 180a-180N. In yet other embodiments, reservation servers 130a-130N can be used to provide capacity for such things as large amounts of users or data storage in reservation system 100B. Similarly, databases 134a-134N can be directly coupled to each of reservation servers 130a-130N to provide backup, redundancy, and/or geographic distribution. In other embodiments, databases 134a-134N can be attached to a network such that reservation servers 130a-130N are in communication with databases 134a-134N via a network as discussed in relation to reservation system 100A, and can be distributed independent of reservation servers 130a-130N.

Reservation servers 130a-130N can be separate physical computer servers and/or co-hosted or virtual servers on a single physical computer server. Similarly, hotels 180a-180N can be different hotels and/or multiple computer servers (physical or virtual as described above) associated with a single hotel. Event planner terminals 120a-120N can be operated by multiple members of a team of event planners coordinating a single event and/or independent one of another.

FIG. 2 illustrates a system block diagram of a representative computing device used in the reservation system of FIGS. 1A and 1B. Computing device refers to invitee terminals 110a-110N, the event planner terminal 120, the reservation server 130, and the hotel 180. FIG. 2 shows computing device 200 including processor 210 operatively coupled to memory 220 and network interface 230 coupled to computer network 140 via connection 250. Connection 250 in FIG. 2 is representative of connections 170a-170N, 160, 150, and 190 from FIGS. 1A and 1B. In some embodiments, connection 250 can be an Ethernet cable. In other embodiments, connection 250 can be a coaxial or fiber optic cable. In yet other embodiments, connection 250 can be a wireless link or connection such as, for example, a cellular link or a Wi-Fi link. Network 140 can be, for example the Internet, a dedicated computer network, an intranet, a cellular network, or any other network capable of effecting communication between computing devices.

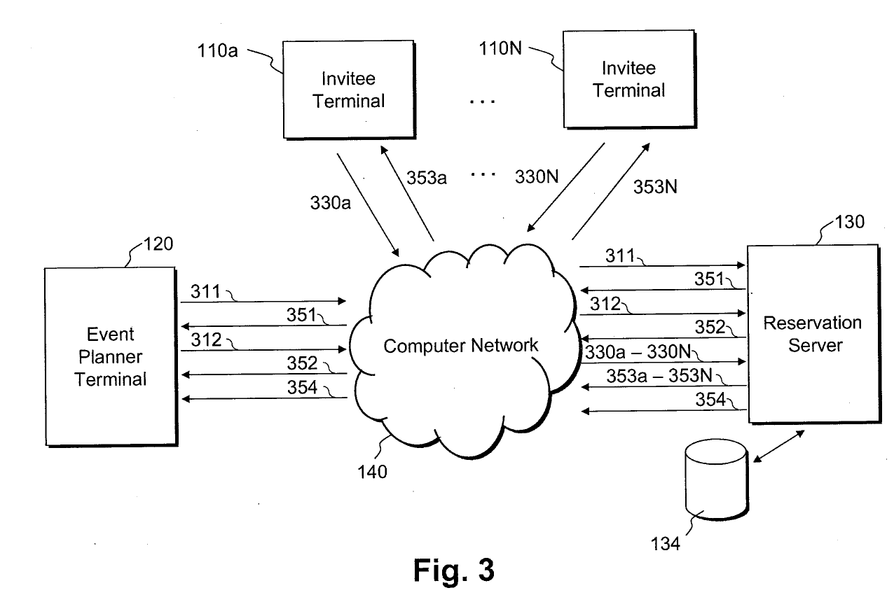

FIG. 3 shows a system block diagram of a reservation system depicting various interactions between devices in the reservation system depicted, according to an embodiment of the invention. FIG. 3 shows invitee terminals 110a-110N, the event planner terminal 120, and the reservation server 130 connected to the computer network 140. In one embodiment, the event planner terminal 120 and/or a hotel (not shown) sends data 311 to the reservation server 130 using the computer network 140 to allocate an inventory of rooms for reservation for an event. The reservation server 130 receives data 311 and can communicate with database 134 to check whether the inventory of rooms is available for reservation from the hotel(s). The reservation server 130 then sends data 351 to the event planner terminal 120 indicating whether or confirming that the requested inventory of rooms is allowed and if so can update the database 134 to indicate that the inventory of rooms is reserved for an event. In some embodiments, the event planner terminal 120 can send to the reservation server 130 data 312 associated with an inventory of rooms specifying either one or more conditions, a schedule for a one-time or periodic notification, or both. In some embodiments, the reservation server 130 can send data 352 to the event planner terminal 120 to, for example, acknowledge that the condition and/or schedule was established. After a condition or schedule is established, the reservation server 130 sends a notification to each identified recipient (such as one or more event planners and/or one or more hotels) when the condition or schedule is met. The reservation server 130 can store the condition in, for example, the database 134.

Invitee terminals 110a-110N can send data associated with reservation requests 330a-330N to the reservation server 130 to reserve a room from an inventory of rooms. The reservation server 130 can process the reservation requests by, for example, accessing the database 134 to determine whether a room in the inventory is available for the reservation request and indicating in the database 134 that a room has been reserved if the reservation was successful. In some embodiments, reservations server 130 can send data 353a-353N to invitee terminals 110a-110N acknowledging the reservation requests and whether they were successful. Invitee terminals 110a-110N can receive data 353a-353N indicating to an individual invitee whether the reservation request was successful.

In some embodiments, the reservation server 130 accesses data associated with invitee accounts or profiles stored in the database 134. Data 330a-330N includes data associated with an invitee account. The reservation server 130 can use data 330a-330N to store registration data in the database 134 such that that reservation data is accessible to invitees through the reservation server 130. As the reservation server 130 receives and processes reservation requests, the reservation server 130 determines whether the latest request satisfies any event conditions or schedules. When the condition or schedule is met, the reservation server 130 may send data 354, which includes a notification to the event planner terminal 120 and/or to any of the one or more configured and identified recipients of the notification. In some embodiments, data 354 is sent to a device other than the event planner terminal 120 such as, for example, an electronic mail (email) server, a cellular phone, or some other device of each of the recipients operatively coupled to the computer network 140.

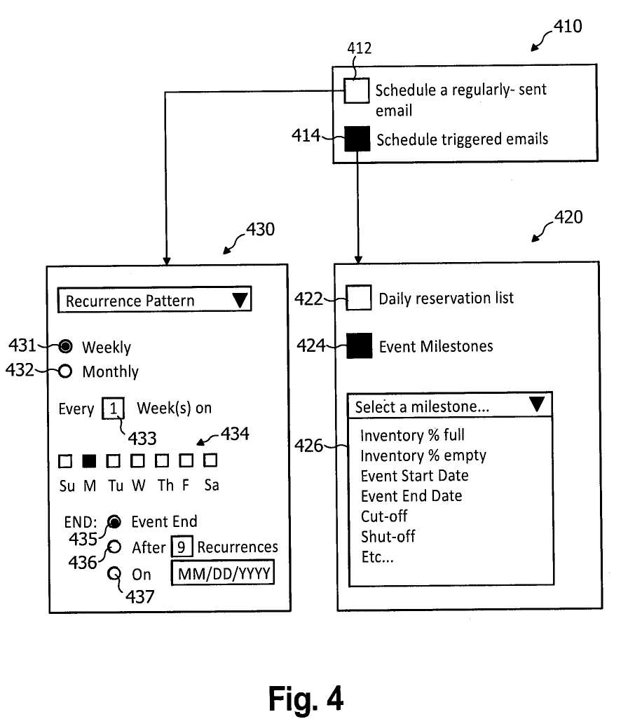

FIG. 4 shows a series of web pages for selecting a notification, according to an embodiment of the invention. As described above, after an inventory of rooms is allocated for an event, an event planner, hotel, and/or someone else may indicate a condition for the sending of a notification and/or can schedule a notification including a report. An event planner can indicate to a reservation server, for example, by clicking on a button in a web page generated by the reservation server, whether a scheduled notification or a condition-based notification will be used. For example, on web page 410, an event planner can click on button 412 to schedule a notification or button 414 to indicate a condition-based notification. After an event planner has clicked on button 412, a reservation server can present a web page for scheduling a notification to the event planner. Web page 430 illustrates one embodiment of a web page for scheduling a notification. Web page 430 includes radio button 431 for selecting a weekly report, radio button 432 for selecting a monthly report, field 433 for indicating a notification frequency, radio buttons 434 for selecting a day of the week for the notification, and radio buttons 435, 436 and 437 for indicating when the notification will end. Similarly, after an event planner has clicked on button 414, a reservation server can present a web page for indicating a condition to the event planner. Web page 420 illustrates one embodiment of a web page for scheduling a notification. Web page 420 includes radio buttons 422 and 424 for selecting between two types of conditions. As shown in FIG. 4, radio button 424 is selected and the event planner is presented with list 426 including event milestones from which the event planner can select a milestone for a condition. In other embodiments, a reservation server can request additional information from event planner based on the type of notification. In some embodiments, the reservation server allows an event planner, hotel employee, and/or someone else interacting with the reservation server to indicate multiple types of notifications. Thus, event planners and other users of the reservation server can both indicate conditions and schedule reports for a single event.

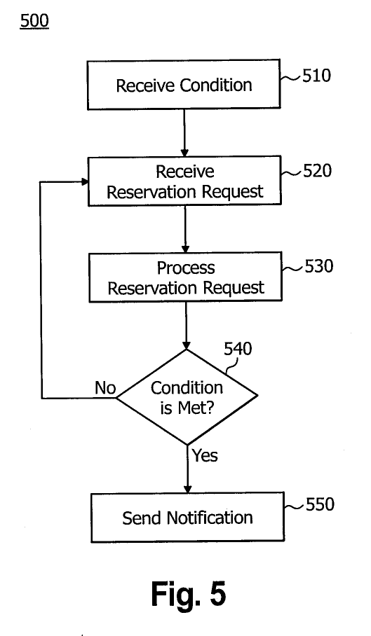

FIG. 5 is an exemplary flow chart for providing a notification, according to an embodiment of the invention. Process 500 illustrates a process implemented by or on a reservation server including, for example, the following steps: receive condition 510, receive reservation request 520, process reservation request 530, determine if the condition is met 540, and send notification 550. As discussed above, an event planner and/or one or more others can be allowed to indicate a condition associated with an inventory of rooms available for reservation. Conditions can be based on various parameters including, for example, the number or percentage of rooms available in an inventory of rooms, the number or percentage of rooms reserved in an inventory of rooms, the number or percentage of specific types of rooms, arrival dates of invitees, and departure dates of invitees. Furthermore, a condition can include a threshold for a given parameter. For example, a threshold can be a percentage of rooms available for reservation. Process 500 receives a condition at receive condition 51O. Process 500 then moves to step 520 receive reservation request. A reservation can be requested when, for example, an invitee to an event accesses a reservation server using a web page provided by the reservation server and a computer running a web browser to RSVP to an event. After a reservation request has been received, process 500 processes the reservation request at process reservation request 530. Processing a reservation request can include, for example, charging a credit card of the invitee requesting the reservation, verifying that the room requested is available, and indicating in, for example, a database storing data associated with the inventory of rooms, that the requested room has been reserved. In some embodiments, the reservation server indicates to an invitee that the reservation request has been processed, for example, by updating a web page displayed in a web browser running on a computer used by the invitee to make the reservation request.

After the reservation request has been processed or on a scheduled basis, process 500 checks if the condition is met at 540. In some embodiments, the condition is checked (540) according to some predetermined or configurable schedule and is not tied necessarily to the receipt or processing of any reservation requests. A reservation server can maintain a list of conditions and associated parameters for checking if a condition is met at step 540, and this list can be stored in any storage medium such as a database. Each time a reservation request is processed, the reservation server updates the parameters affected by the reservation, if any, and triggers or sends a notification if appropriate, or else the notification is sent as a result of the scheduled condition checking. For example, a notification can be sent if a particular condition is met because the parameter associated with the condition has reached the identified and set threshold. In another embodiment, the reservation server maintains a list of the status of each room in the inventory of rooms and scans the list to determine if a condition is met. This list can be stored in any storage medium such as a database. In yet other embodiments, process 500 can check if a condition is provisionally or will be met by a requested reservation before processing the reservation request and, if the condition is met after the request is processed, send a notification after processing the reservation request. Alternatively, the notification can be sent based on the determination that the condition is provisionally met. If a condition is not met, process 500 can return to step 520 to receive another reservation request. In some embodiments, process 500 can return to step 520 to receive additional reservation requests after a notification is sent at step 550.

In some embodiments, process 500 can allow an event planner and/or one or more others to indicate multiple conditions and at step 540 determine whether any condition is met. Process 500 can then send a notification for each condition that is met. In other embodiments, a notification can be sent at a specified time rather than immediately when a condition is met. In yet other embodiments, notifications for multiple conditions that have been met can be consolidated or aggregated into a single message. In still other embodiments, process 500 can receive reservation requests before any conditions are received. Similarly, additional conditions can be received after process 500 has received reservation requests. The conditions can be evaluated to check if a condition is met immediately after the condition is received and/or after a subsequent reservation request is received.

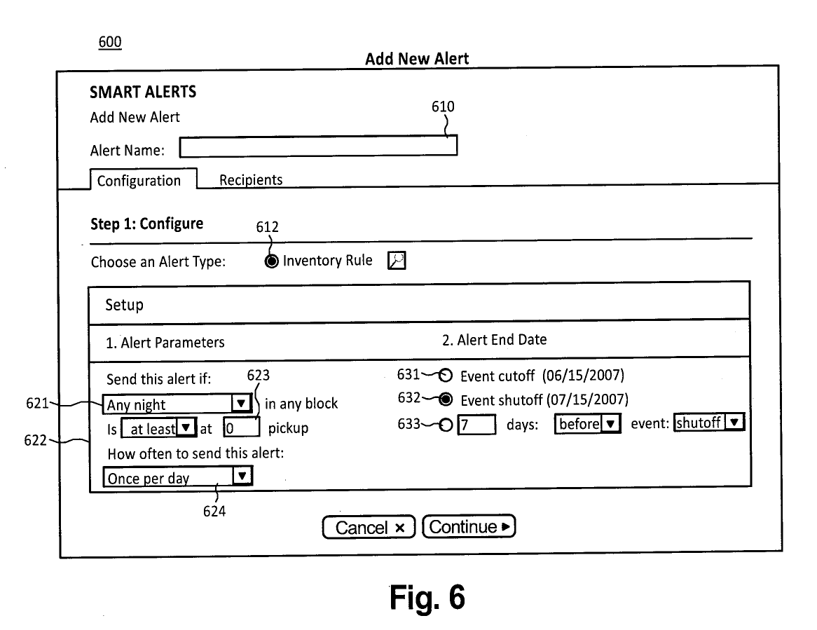

FIG. 6 illustrates a web page for configuring parameters of a notification, according to an embodiment of the invention. Web page 600 includes field 610 for providing a name or identifier of the alert or condition, radio button 612 for selecting a type of condition, field 624 for indicating the time the notification will be sent, field 621 for indicating a frequency of the notification, and fields 622 and 623 for indicating a threshold for a condition. In some embodiments, an event planner and/or one or more other users of the reservation server can indicate start and end dates for conditions and/or thresholds based on a selection of, for example, radio buttons 631, 632, and 633. In other embodiments, a user can indicate a condition based on predetermined options or parameters. In yet other embodiments, the reservation server can allow a user to input specific values for the conditions. In still other embodiments, a user can be allowed to indicate a condition based on a combination of predetermined options and specific values input by the user. Conditions can include, for example, the number or percentage of rooms available in an inventory of rooms, the number or percentage of rooms reserved in an inventory of rooms, the number or percentage of rooms with a particular feature, arrival dates of invitees, or departure dates of invitees.

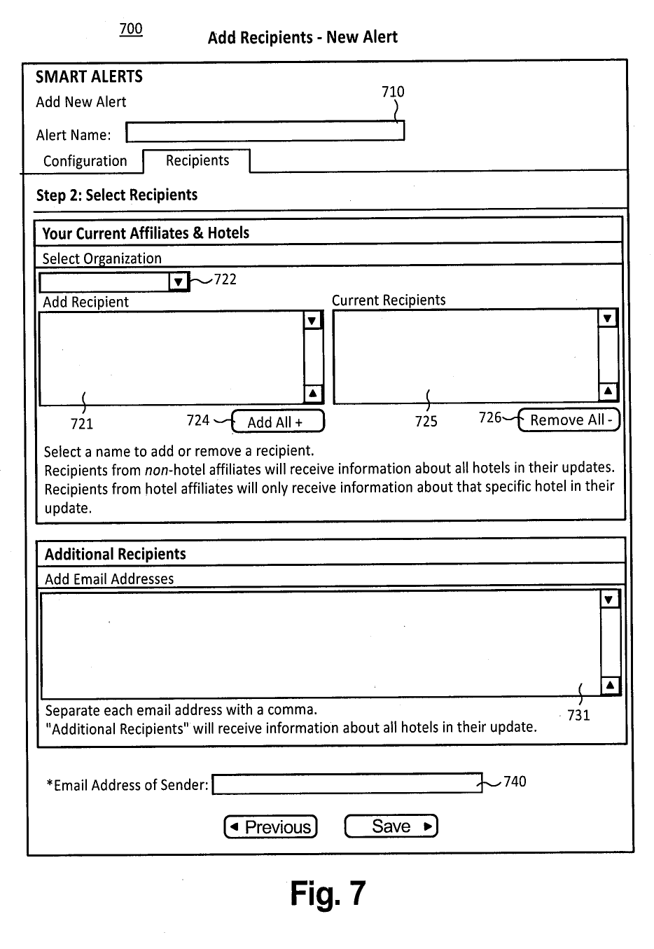

FIG. 7 illustrates a web page for selecting recipients of a notification, according to an embodiment of the invention. Web page 700 includes alert name field 710, list 722 for selecting an organization as a recipient, fields 721 and 731 for input of recipients, list 725 of current recipients, button 724 for adding recipients from fields 721 and 731 to list 725, button 726 for removing recipients from list 725, and field 740 for indicating a notification reply email address. As discussed above, a reservation system can allow an event planner and/or other user(s) to select or input recipients of notifications sent in response to conditions or schedules. For example, an event planner can add recipients by inputting the recipient in field 721 and clicking on button 724 to add the recipients from field 721 to list 725. In some embodiments, the notifications can be electronic mail messages sent to an electronic mail address associated with each recipient. In other embodiments, the notifications can be messages sent using an instant messaging (IM) protocol to an instant messaging identifier associated with each recipient. In yet other embodiments, the notifications can be sent using a short message service (SMS) over a cellular network and a phone number can be associated with each recipient. Recipients can be, for example, the event planner, other event planners, one or more employees of the hotels, invitees, or any other recipient. Recipients can similarly be input or selected for scheduled reports.

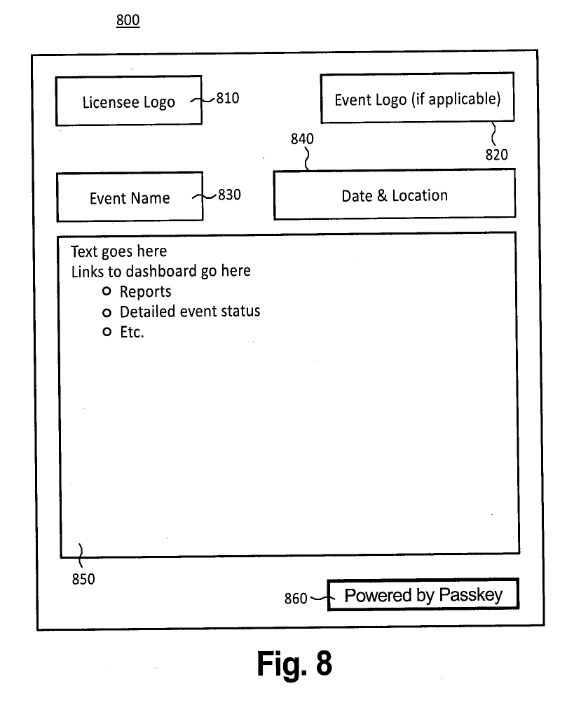

In some embodiments, a reservation system according to the invention allows an organizer of an event (such as an event planner or hotel employee(s)) to customize the notification that will be sent. FIG. 8 illustrates a template for an email notification, according to an embodiment of the invention. Template 800 can be branded by, for example, allowing an event organizer to indicate a logo of an event 820, a logo of a licensee of the reservation system 810, and/or a logo of the reservation system 860. In some embodiments, an event name can be included in field 830 and a date and location can be included in field 840. Additionally, in some embodiments, a user can determine the format of the notification including the manner in which information is displayed in the email body 850. For example, a reservation system can produce graphs and other graphics to represent information in the notification and/or use text to convey information based on a format specified by the user. In some embodiments, a different format can be specified for and sent to different recipients. For example, one notification format can be sent to email recipients and a different notification format can be sent to SMS and IM recipients. In other embodiments, a notification or report can be attached to an email message, rather than embedded within the body of the email.

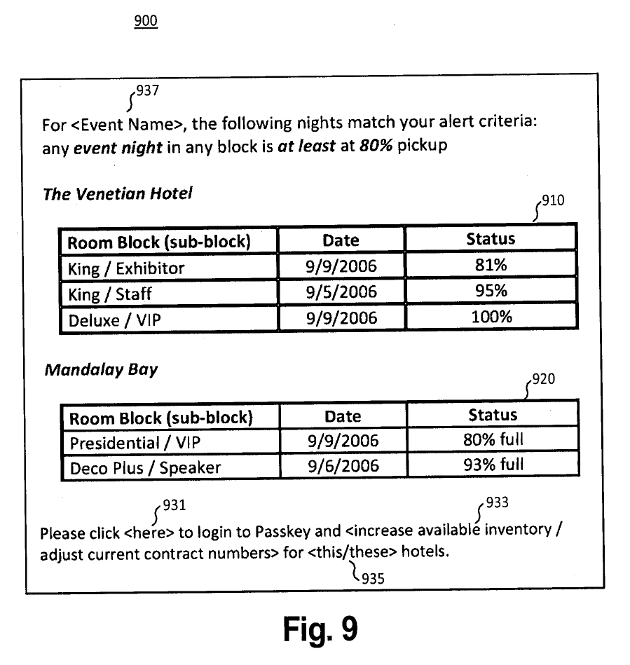

FIG. 9 illustrates one example of an email notification, according to an embodiment of the invention. Email notification 900 in FIG. 9 uses both text and graphical tables to represent information. For example, table 910 displays information about an inventory of rooms at one hotel, table 920 displays information about an inventory of rooms at another hotel, fields 933 and 935 include textual information about one or more inventories of rooms, and field 937 includes an event name. In some embodiments, as shown in FIG. 9, a notification can include hyperlinks such as hyperlink 931. Such hyperlinks can direct a recipient of the notification to the reservation system using an Internet browser, for example, to view more detailed information associated with the notification or make changes to the inventory based on the notification. FIG. 9 also illustrates aggregation or consolidation of notifications. In some embodiments, as illustrated in FIG. 9, a notification can include information about multiple hotels or inventories of rooms. Similarly, in other embodiments, information about multiple events can be consolidated into a single notification. In yet other embodiments, notifications can be held by a reservation system and delivered periodically such as, for example, daily, weekly, or monthly. Thus, the reservation system can consolidate all or some notifications for a particular recipient based on preferences of the recipient and/or someone else and/or based on defaults of the reservation system. For example, the reservation system can default to consolidate all, some, and/or only notifications that are related by, for example, hotel, inventory, and/or event. Thus, an event planner or other user organizing multiple events can receive a single notification that includes information about multiple inventories of rooms for multiple events.

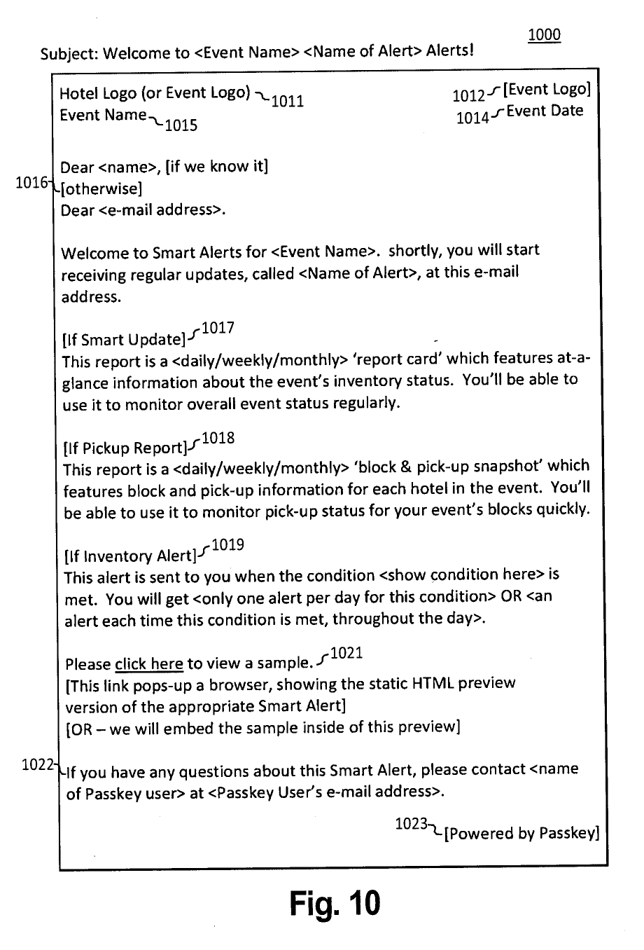

In some embodiments, when a user is added as notification recipient, a reservation system can send a message to that user indicating that he or she has been added as a notification recipient and will receive future notifications. FIG. 10 illustrates an exemplary email 1000 for informing a user that notifications will be sent to that user, according to an embodiment of the invention. Similar to notifications, the reservation system can allow a user to specify the format and/or content of the message. Additionally, in some embodiments, the message can be branded and/or include hyperlinks. Email 1000 includes hotel logo field 1011, event logo field 1012, event date field 1014, event name field 1015, and reservation system logo field 1023 for branding email 1000. Email 1000 also includes addressee field 1016, description of notification 1017, description of notification 1018, description of notification 1019, hyperlink 1021 for viewing sample notifications, and event planner contact information field 1022.

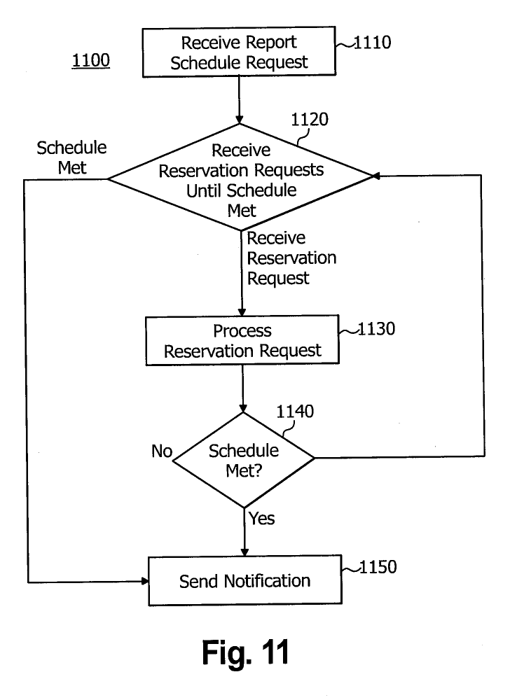

FIG. 11 is a flow chart illustrating notification scheduling, according to an embodiment of the invention. Process 1100 illustrates a process implemented by, for example, a reservation server including the following steps: receive report schedule request 1110, receive reservation requests until schedule is met 1120, process reservation request 1130, check schedule met 1140, and send notification 1150. A reservation system implementing process 1100 can allow an event planner or other user to schedule a report for receiving a notification. For example, the reservation server can receive data associated with a request to schedule a report from event planner terminal over a computer network. A request to schedule a report can include report settings such as, for example, a time to send, information to be included, frequency, and format. In some embodiments, process 1100 can allow an event planner or other user to request multiple reports.

In some embodiments, after process 1100 receives a request to schedule a report, process 1100 then is ready to receive reservation requests. Process 1100 can be implemented on, for example, a reservation server and be configured to receive reservation requests from invitees using, for example, computers operatively coupled to a computer network. While receiving reservation requests, process 1100 determines whether a notification including a report should be sent based on an associated schedule. If the schedule is met while process 1100 is waiting to receive a reservation request, process moves from step 1120 to step 1150 to send a notification including the report. In some embodiments, process 1100 can return to step 1120 after sending the notification to continue receiving reservation requests. If process 1100 receives a reservation request before the schedule is met, process 1100 can move to step 1130 to and processes the received reservation requests. In some embodiments, as illustrated in FIG. 11, after processing the received reservation request, process 1100 can check whether the schedule is met. If the schedule is not met, process 1100 can return to step 1120 to receive reservation requests. If the schedule is met, process 1100 can move to step 1150 to send the notification including the report.

In some embodiments, multiple reports may be scheduled. Process 1100 can monitor or check the multiple schedules at steps 1120 and/or 1140 and send the notification including the report associated with each schedule. In other embodiments, step 1150 can include combining or consolidating multiple reports, the schedules for which are each met, prior to sending a notification such that a single notification including each report is sent by step 1150. In other embodiments, only some of the reports are scheduled into a single notification based on, for example, preferences in the schedule established by the event planner or other user. In yet other embodiments, process 1100 can receive reservation requests before any reports are scheduled. Similarly, additional reports can be scheduled after process 1100 has received reservation requests. A schedule may be evaluated to determine whether the schedule is met once the schedule is established.

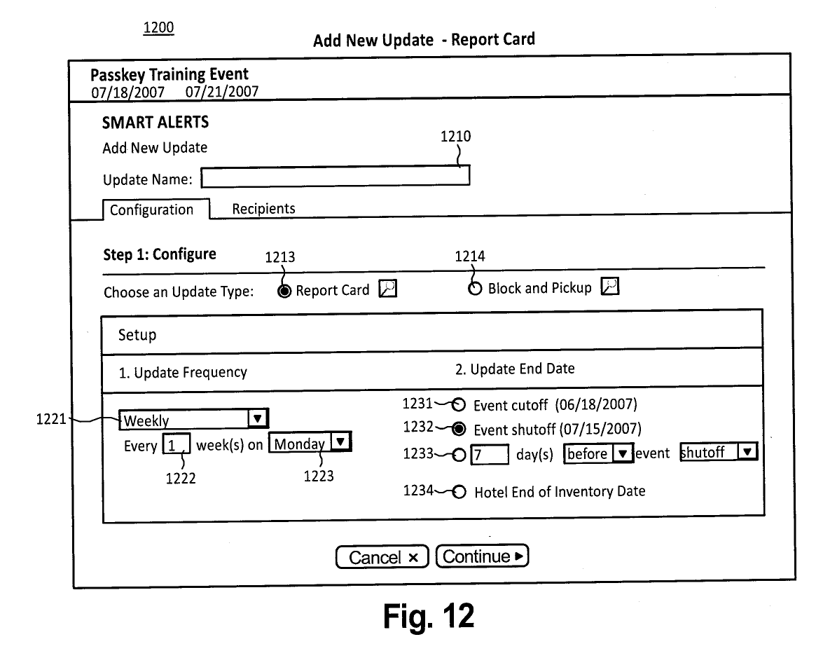

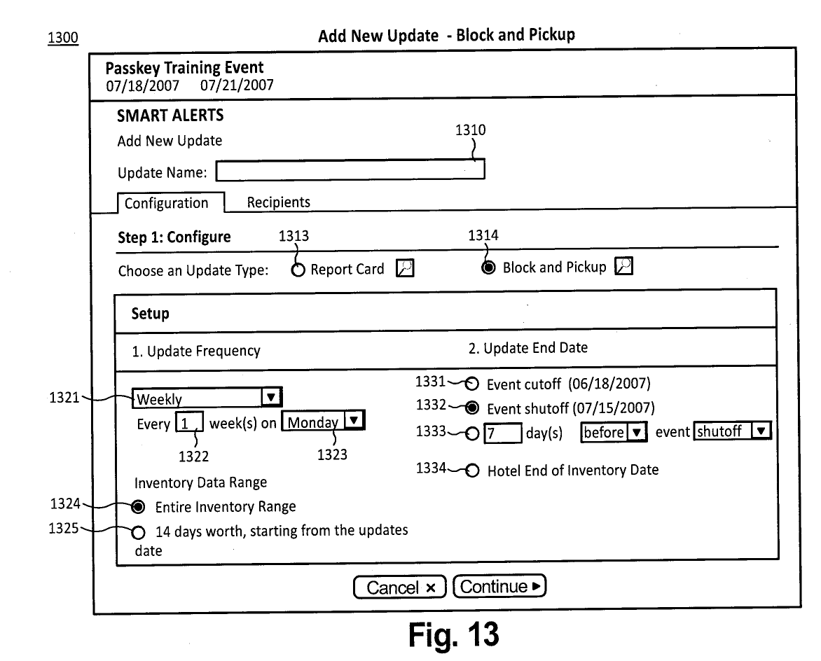

FIGS. 12 and 13 illustrate web pages 1200 and 1300, respectively, for configuring parameters of a notification, according to an embodiment of the invention. Web page 1200 includes notification name field 1210, radio button 1213 for selecting a “Report Card” report, radio button 1214 for selecting a “Block and Pickup” report, list 1221 for selecting a report frequency, fields 1222 and 1223 for refining the report frequency, and radio buttons 1231, 1232, 1233, and 1234 for configuring a report end date. Web page 1300 includes notification name field 1310, radio button 1313 for selecting a “Report Card” report, radio button 1314 for selecting a “Block and Pickup” report, list 1321 for selecting a report frequency, fields 1322 and 1323 for refining the report frequency, radio buttons 1324 and 1325 for selecting a range of dates for the report, and radio buttons 1331, 1332, 1333, and 1334 for configuring a report end date In some embodiments, reports can be scheduled to be sent periodically at time periods including, for example, daily, weekly, monthly, and/or for an interval of days. Additionally, reports can include various forms of information. FIG. 12 shows a web page 1200 for scheduling a “Report Card” report. A “Report Card” report can include, for example, the number or percentage of rooms available in the inventory. FIG. 13 shows a web page 1300 for scheduling a “Block and Pickup” report. A “Block and Pickup” report can include, for example, the percentage or number of rooms in the inventory that have been reserved. In other embodiments, reports can include other information including, for example, arrival and departure dates and/or other information about the inventory of rooms.

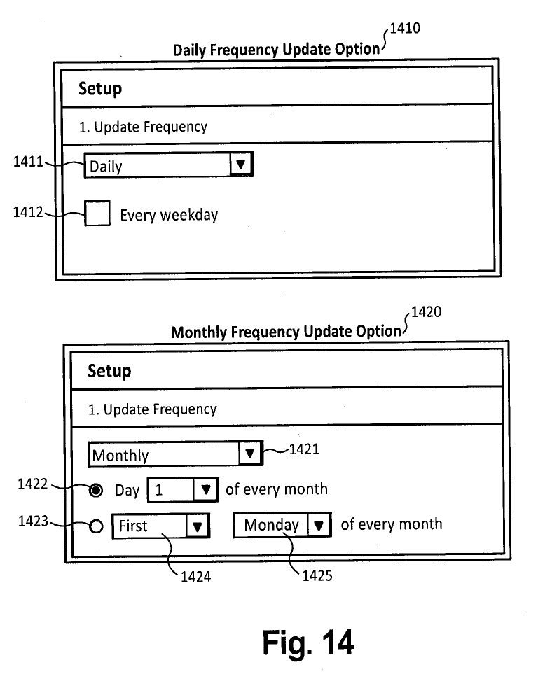

FIG. 14 illustrates web pages 1410 and 1420 for scheduling a notification, according to an embodiment of the invention. Web page 1410 includes list 1411 for selecting a notification frequency and checkbox 1412 for configuring notifications to be sent only on weekdays. Web page 1420 includes list 1421 for selecting a notification frequency and radio buttons 1422 and 1423 for refining a notification frequency. Additionally, web page 1420 includes fields 1424 and 1425 for refining a notification frequency when radio button 1423 is selected.

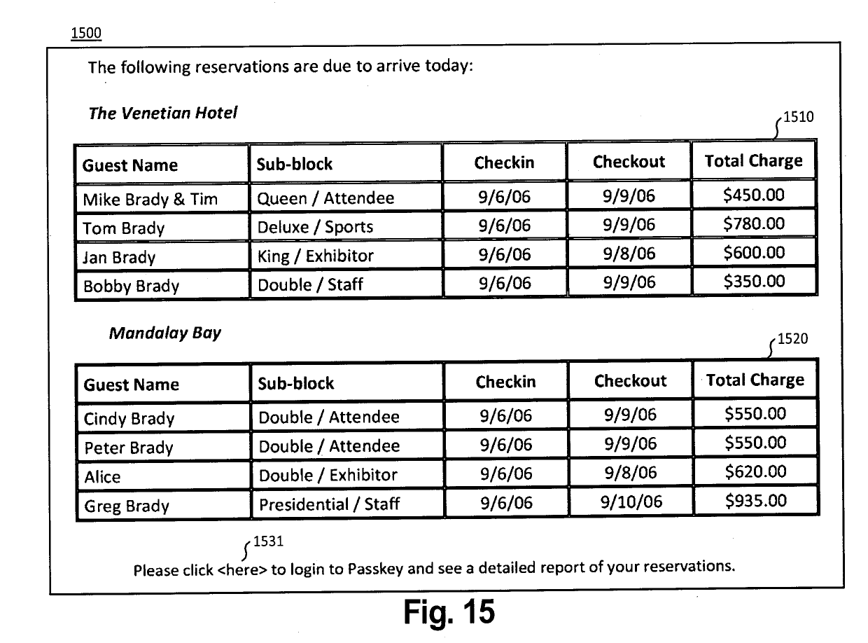

FIG. 15 illustrates an exemplary email notification, according to an embodiment of the invention. The email notification 1500 uses both text and graphical tables 1510 and 1520 to represent information. In some embodiments, as shown in email notification 1500, a notification can include references to additional information about a report or condition. For example, a hyperlink 1531 can direct a recipient of a notification from the reservation system, for example, to a web page to view more detailed information associated with the notification or make changes to the inventory based on the notification. FIG. 15 also shows aggregation or consolidation of notifications. In some embodiments, as shown in FIG. 15, a notification can include information about multiple hotels or inventories of rooms. Table 1510 includes information about an inventory of rooms associated with one hotel and table 1520 includes information about an inventory of rooms associated with a different hotel. Similarly, in other embodiments, information about multiple events can be consolidated into a single notification. In yet other embodiments, notifications can be held by a reservation system and sent periodically such as, for example, daily, weekly, or monthly. Additionally, the reservation system can consolidate all or some notifications for a particular recipient based on preferences of the recipient and/or other user and/or based on defaults of the reservation system. For example, the reservation system can default to consolidate all, some, and/or only notification that are related by, for example, hotel, inventory, and/or event.

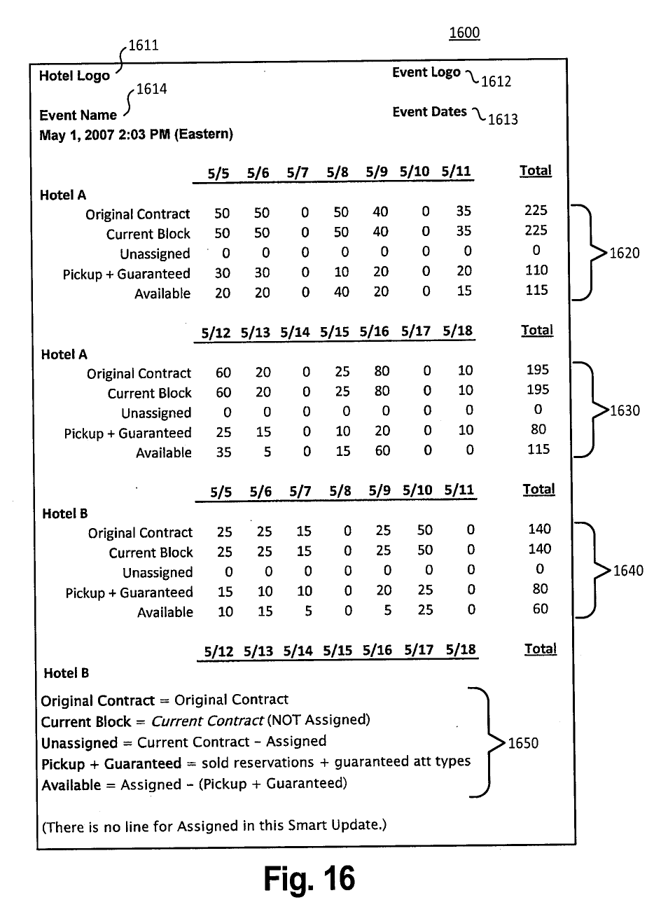

As discussed in relation to condition-based notifications and FIG. 8, notifications including reports can be customized or branded. FIG. 16 shows an example of an email notification, according to an embodiment of the invention. Email 1600 in FIG. 16 includes an event logo field 1612, a hotel logo field 1611, an event name field 1614, an event date field 1613, hotel data field 1620, hotel data field 1630, hotel data field 1640, and an explanation of hotel data 1650. In FIG. 16, the event planner or other user of the reservation system scheduling the report configured hotel data field 1620, hotel data field 1630, and hotel data field 1640 to be in a tabular format. Additionally, email 1600 is an example of a consolidated notification including information associated with multiple hotels and date ranges. Hotel data field 1620 represents data associated with “Hotel A” and hotel data field 1640 represents data associated with “Hotel B.” Similarly, hotel data field 1620 represents data associated with “Hotel A” for one range of dates and hotel data field 1630 represents data associated with “Hotel A” for another range of dates.

Some embodiments include a processor and a related processor-readable medium having instructions or computer code thereon for performing various processor-implemented operations. Such processors can be implemented, for example, as hardware modules such as embedded microprocessors, microprocessors as part of a computer system, Application-Specific Integrated Circuits (“ASICs”), and Programmable Logic Devices (“PLDs”). Such processors can also be implemented as one or more software modules in programming languages as Java, C++, C, assembly, a hardware description language, or any other suitable programming language. A processor according to some embodiments includes media and computer code (also can be referred to as code) specially designed and constructed for the specific purpose or purposes. Examples of processor-readable media include, but are not limited to: magnetic storage media such as hard disks, floppy disks, and magnetic tape; optical storage media such as Compact Disc/Digital Video Discs (“CD/DVDs”), Compact Disc-Read Only Memories (“CD-ROMs”), and holographic devices; magneto-optical storage media, and read-only memory (“ROM”) and random-access memory (“RAM”) devices. Examples of computer code include, but are not limited to, micro-code or micro-instructions, machine instructions, such as produced by a compiler, and files containing higher-level instructions that are executed by a computer using an interpreter. For example, an embodiment of the invention may be implemented using Java, C++, or other object-oriented programming language and development tools. Additional examples of computer code include, but are not limited to, control signals, encrypted code, and compressed code.

While certain embodiments have been shown and described above, it will be understood by those skilled in the art that various changes in form and details may be made. For example, some embodiments that have been described in relation to condition-based notifications can be useful in embodiments including scheduled notifications including reports. Other embodiments that have been described in relation to a particular message type or medium can be used with other message types. For example, some embodiments discussed in relation to email can be used with IM protocols. Furthermore, it should be understood that the systems and methods described herein can include various combinations and/or sub-combinations of the components and/or features of the different embodiments described. Thus, embodiments described with reference to conditions can be combined with embodiments using scheduled notifications including reports.

What is claimed is:

1. A computer-implemented method of providing a notification over a network, comprising:
allowing at least one person associated with an event to identify at least one condition associated with an inventory of rooms available for reservation in connection with the event;
receiving over the network one or more room reservation requests, each of the requests being for a reservation of one or more of the rooms in the inventory;
determining whether the at least one condition associated with the inventory is met after the one or more requests are received; and
providing the notification over the network if the at least one condition is met.

2. The method of claim 1 wherein the allowing step comprises allowing the at least one person to set an amount of reserved rooms in the inventory, and wherein the determining step comprises determining whether the amount is reached.

3. The method of claim 1 wherein the allowing step comprises allowing the at least one person to set a percentage of reserved rooms in the inventory, and wherein the determining step comprises determining whether the percentage is reached.

4. The method of claim 1 wherein the at least one condition comprises at least one of an amount of reserved rooms in the inventory and a percentage of reserved rooms in the inventory.

5. The method of claim 1 wherein the providing step comprises sending an electronic mail message over the network if the at least one condition is met.

6. The method of claim 5 wherein the electronic mail message includes information about the condition.

7. The method of claim 5 wherein the electronic mail message includes a reference to information about the condition.

8. The method of claim 1 wherein the providing step comprises sending the notification over the network to at least the at least one person if the at least one condition is met.

9. The method of claim 8 wherein the providing step comprises sending the notification over the network to the at least one person and also to one or more other recipients associated with the event.

10. The method of claim 1 further comprising:
allowing the at least one person to identify at least one other condition associated with a different inventory of rooms available for reservation in connection with a different event; and
receiving over the network one or more room reservation requests for reserving one or more rooms in the different inventory.

11. The method of claim 10 wherein the providing step comprises sending the notification if both the at least one condition and the at least one other condition are met.

12. A computer-implemented method of managing an inventory of rooms over a network, comprising:
offering the inventory of rooms to invitees of an event for reservation;
identifying at least one condition for triggering the sending of information associated with the inventory of rooms; and
receiving a notification over the network after the at least one condition is met.

13. The method of claim 12 further comprising:
identifying one or more recipients of the notification over the network.

14. The method of claim 12 further comprising:
determining the format of the notification over the network.

15. A computer-implemented method, comprising:
allowing at least one person associated with an event to schedule at least one report associated with an inventory of rooms available for reservation in connection with the event;
receiving over a network one or more room reservation requests, each of the requests being for a reservation of one or more of the rooms in the inventory; and
sending the at least one report over the network.

16. The method of claim 15 wherein the allowing step comprises allowing the at least one person to identify the contents of the at least one report and also when the at least one report will be sent.

17. The method of claim 15 wherein the sending step comprises sending an electronic mail message over the network, the electronic mail message including the at least one report.

18. The method of claim 17 wherein the at least one report is attached to the electronic mail message.

19. The method of claim 17 wherein the at least one report is contained within the electronic mail message.

20. The method of claim 15 wherein the sending step comprises sending an electronic mail message over the network, the electronic mail message including a reference to the at least one report.

21. The method of claim 16 wherein the allowing step further comprises allowing the at least one person to identify the format of the at least one report.

22. The method of claim 15 wherein the sending step comprises sending the at least one report over the network to the at least one person and also to one or more other recipients associated with the event.

23. The method of claim 16 wherein the allowing step further comprises allowing the at least one person to identify that the at least one report will be sent periodically.

24. The method of claim 16 wherein the allowing step further comprises allowing the at least one person to identify that the at least one report will be sent daily, weekly, or monthly.

25. The method of claim 15 further comprising:
allowing the at least one person to schedule at least one other report associated with a different inventory of rooms available for reservation in connection with a different event; and
receiving over the network one or more room reservation requests for reserving one or more rooms in the different inventory.

26. The method of claim 25 wherein the sending step comprises sending a single report that includes both the at least one report and the at least one other report.

27. A computer-implemented method of managing an inventory of rooms over a network, comprising:
offering the inventory of rooms to invitees of an event for reservation;
scheduling at least one report associated with the inventory of rooms; and
receiving the at least one report over the network.

28. The method of claim 27 further comprising:
determining the content of the at least one report associated with the inventory of rooms.

29. A computer system for providing a notification over a network, comprising:
a network interface configured to be in communication with the network;
storage configured to store data associated with an inventory of rooms available for reservation by invitees of an event; and
a processor in communication with the network interface and the storage, the processor configured to:
receive one or more conditions associated with the inventory,
receive over the network one or more requests for reserving one or more rooms from the inventory,
determine whether the one or more conditions are met, and
transmit the notification over the network if at least one of the one or more conditions is met.
